(19) United States
(12) Patent Application Publication
(10) Pub. No.: US 2012/0287554 A1
(43) Pub. Date: Nov. 15, 2012

(54) PATTERNED METALLIZED FILM WITH ENHANCED UNDERLAYER FOR METALLIZED CAPACITOR APPLICATIONS

(75) Inventor: Terry Hosking, Barre, VT (US)

(73) Assignee: S B E, INC., Barre, VT (US)

(21) Appl. No.: 13/397,105

(22) Filed: Feb. 15, 2012

Related U.S. Application Data
(60) Provisional application No. 61/443,439, filed on Feb. 16, 2011.

(51) Int. Cl. H01G 4/32

(52) U.S. Cl. 361/301.5

(57) ABSTRACT

A technique is described for increasing the capacitance of a metallized polymer film capacitor where the capacitor electrodes have been fabricated with so-called patterned film. The pattern as typically embodied by prior art allows the capacitor to better survive dielectric failures, or exhibit improved tolerance to extreme pulse current. The pattern is created by areas on the capacitor electrodes which have no metal, so there will be a capacitance reduction penalty for using said patterned electrodes. Each section of the pattern is connected by a local fuse, which is disconnected from the rest of the capacitor when the current flowing through a defect vaporizes the surrounding metal. An extremely light metallization underlayer is described which allows the better survival characteristic provided by pattern film should a dielectric failure occur, yet mitigates the capacitance loss previously seen for capacitors made with conventional patterned metallized electrodes on the capacitor film.

This application is a non provisional of U.S. provisional application 61/443,439 “Pattern Film with Enhanced Underlayer” filed Feb. 16, 2011. This application claims all priority and benefit of the preceding provisional application.

### FIELD OF THE INVENTION

The present invention relates to a method of mitigating the capacitance reduction encountered in prior art polymeric metallized film capacitors where the vacuum deposited metal electrodes are fabricated with a pattern of missing metal such that the capacitor has improved tolerance to dielectric failures.

### BACKGROUND OF THE INVENTION

Capacitors are advantageously constructed using vacuum deposited electrodes on polymer films of various types. Such films are generally referred to as metallized film, with the metallization thickness best defined as a sheet resistance defined by resistance/square, (e.g. thick metal has a low value ohms/square). Metallization thickness generally defines a film's ability to carry current and to allow for self healing: the ability of metallized film to vaporize adjacent to a dielectric fault site, isolating the fault, and allowing the capacitor to continue reliable operation. A problem with this self-healing process occurs when the energy into a fault is sufficient to heat the wound layers above and below that layer where a dielectric fault occurs enough to cause additional dielectric failures. This is more likely to occur at higher capacitor operating temperatures, as the energy needed to melt adjacent layers is reduced as temperature rises. It also becomes a problem if the force between layers is high enough to restrict metal vaporization around a dielectric fault site. Capacitor manufacturers have addressed the problem via the use of patterned metallization. The use of this patterned film is a well known prior art. Refer to FIG. 1 for one simple embodiment of a prior art patterned metallization (1). An example of more recent prior art is described by Okuno et al. U.S. Pat. No. 5,905,628 [May 18, 1999]. Also shown in FIG. 1 and FIG. 1a is the use of another advantageous prior art technique where heavier metallization (2) is used near the connection edge (3) to improve the ability to make electrical connections to the completed capacitor winding after its fabrication. One of several similar embodiments of so called heavy edge metallization is taught by Lavern, U.S. Pat. No. 5,610,796 [Mar. 11, 1997]. The intent of this and other related patterns is to improve the probability that a single point dielectric failure will not cause the capacitor to fail. The electrode diamond squares (4) [or other prior art electrode area geometries] in the active electrode are connected together with thin links of much smaller cross section (5). If a dielectric failure occurs, the current into the area of the fault will rise high enough to cause the restricted cross section(s) to vaporize open, isolating a potential fault area. These (hereafter called) fuses open with sufficiently small energy such that film layers above and below them do not become involved and the film does not melt. This prevents propagation of the dielectric fault to adjacent layers as described above which will eventually result in catastrophic capacitor failure. Another advantageous use for patterned metallization on film is to increase the pulse current tolerance for a metallized film capacitor. Hosking et al. describe this application in U.S. Pat. No. 7,008,838 [Mar. 7, 2006]. FIG. 2 illustrates the use of two of these patterned films arranged so they can be wound into a capacitor showing the active patterned electrode area (8), connection edges (9), and margin (10).

The issues encountered with advantageous use of the pattern film for capacitor fabrication are as follows [reference FIG. 1]:
1) The loss of significant capacitance, which any prior art pattern will cause, as a result of creation of electrode areas with no metallization (6). In fact, on average the capacitance loss will be ˜double the percentage of missing metal because the pattern on each of the patterned films will not overlap exactly at any location along the winding film length. The outer turn of a wound film pair is always very slightly longer than the inner. As a result, during winding, the film pattern alignment will gradually change.
2) The inevitable increase in capacitor equivalent series resistance (ESR) as a result of the capacitor operating current having to flow through the reduced cross section area of the fuses that interconnect the pattern elements.
3) The first row of the above described pattern fuses (7) adjacent to the heavy connection edge must carry the entire capacitor operating current. A sufficient fault current will open these fuses with the same capacitor failure symptom as would occur at the capacitor end connection as described in U.S. Pat. No. 7,008,838 referenced above [FIG. 1 and description in U.S. Pat. No. 7,008,838]. A single fault current pulse can drastically increase the capacitor ESR if the fault opens any of the indicated fuses (7). Subsequent fault current events will open more of these fuses, as the current density in the remaining fuses is now increased. Based on failure analyses of capacitors that utilize patterned film to better tolerate dielectric faults, capacitors occasionally exhibit undesired opening of pattern metallization fuses. Such premature fuse openings constitute a known capacitor reliability problem for some metallization patterns developed as described to improve capacitor resistance to catastrophic dielectric failure.

In spite of the above described issues, the pattern illustrated in FIG. 1 and other pattern designs for similar purposes are often used in the fabrication of film capacitors.

Although not in as common use, there is a known art pattern [FIG. 3] that addresses to some extent the above described capacitance penalty, ESR increase, and undesired fuse opening issues. This is to pattern only part of the active area (11). Specifically, one would pattern only 50% of the active area adjacent to the margin. If two such pattern metallized films are arranged as is done in fabrication of metallized capacitors [FIG. 4], this arrangement will create a capacitor where all un-patterned electrodes face a patterned area on adjacent layers (12). In practice, slightly more than half of the active area toward the margin will be patterned, so there is a small overlap width at the center of the electrode active area where both films are patterned (13).

This modified pattern film maintains the advantages of clearing a fault without relying on metal vaporization around a fault site to isolate the fault. This modified pattern also mitigates to some extent the issues present when using previous pattern film:
1) Reduces the capacitance loss penalty by up to 50% [slightly less in practice].
2) Reduces substantially the ESR penalty as the resistance of the un-patterned film is substantially lower than the resistance of the patterned film.
3) Increases by a factor of 4 the resistance to pulse current events [undesired opening of metallization fuses] as the capacitor current at the active electrode center is reduced by a factor of 2 (14).

All the previous descriptions involve pattern film where the connection edge is thicker than the active electrode area, and the active electrode area is intended to be constant thickness. Another advantageous metallization technique [FIG. 5] is to use metallization where the metal thickness gradually tapers from heavy at the film connection edge (15) across the active area of the capacitor electrode to the margin where the metal is very thin (16) [a so called tapered, or slope metallization]. On average, a higher resistance metallization profile can be used without the usual penalty of highly increased ESR, as the area carrying the most current (17) is near the connection edge where the metallization is thickest [lowest sheet resistance]. FIG. 5 represents one of many suitable slope metallization designs with metal thickness described by sheet resistance measured in ohms/square (18). Slope metallization can advantageously be combined with the pattern film design. FIG. 5a shows the area of the slope or tapered metallization that is patterned (18A) for the pattern geometry shown in FIG. 4.

This is the current known general state of the art for pattern film as applies to capacitor manufacture.

There are other examples where an advantageous layer of material has been applied to a dielectric polymer film prior to applying the electrode metallization [plain or patterned] to enable it to be wound into a capacitor.

Shaw et al. U.S. Pat. No. 5,440,446 [Aug. 8, 1995] teaches that it is advantageous to coat one or both sides of a polymer film with an acrylate layer that can improve the ability of a dielectric film to [among other things] exhibit an improved ability to survive a dielectric point failure compared with that ability without such a coating. This coating is non-conductive and so will not mitigate the capacitance loss issue that the idea of present invention addresses.

U.S. Pat. No. (Hudis et al.), 5,615,078 [Mar. 25, 1997] describes the addition of a semiconducting refractory layer to the film to assist with voltage grading in the margin area, etc. However, this does not claim any capacitance loss mitigation which is the idea of the present invention.

### SUMMARY OF THE PRESENT INVENTION

The idea of the present invention allows all the advantages of using patterned metallization and mitigates all of the capacitance loss penalty that is present with ALL prior art metallization patterns.

The proposed improvement is to first put an extremely thin layer of metal onto the film over the entire electrode area of the film. FIG. 6 shows a cross section describing the addition of the proposed metal first layer (19) concept for the typical diamond pattern metallization. The pattern film (21) and heavy edge (20) layers are then added. This (hereafter called) “underlayer” would be thinner than the pattern layer, such that if a fault occurred it would have minimal impact on the fuse functions enabled by the metallization pattern. The underlayer would also fuse. Since this underlayer is present in the electrode areas left open by the metallization pattern FIG. 1, (6), it will function as part of the electrode. This completely removes the capacitance penalty normally paid for using patterned film. The charge accrued on the underlayer where previously there was no metallization as defined by the pattern (6), will have a very short distance to move to the thicker metallized area of the pattern when the capacitor is charged or discharged. As a result, this extra capacitance is acquired with little or no ESR penalty; in fact, the presence of the underlayer slightly reduces the overall capacitor ESR. The underlayer thickness [defined as a sheet resistance] must be specified by the metallized film user; it needs to be thin enough so that it does not substantially inhibit the opening of metallization “fuses” or inhibit other advantages provided by any metallization pattern.

FIG. 7 shows how the underlayer (19) would be added to the state of the art design shown in FIG. 5a; with slope metallization and partial pattern.

The applicant is very well aware that the choice of underlayer thickness is critical; if chosen too thick the advantage offered by the pattern will disappear. For this case the conductivity in parallel with the pattern fuses would prevent them from carrying enough fault current to open as it is desired they do. If the underlayer thickness target is too thin it may be impossible for a metallizer to reliably produce a desired thickness.

One way to fabricate film with the extra metal layer is to run it through a metallization process twice. The simple thin layer could be put on at a very high rate through the process. In addition, since the metal is so thin and uniform, there should be minimal film distortion and/or shrinkage during the first pass. The process rate for the standard metallization pattern would be at normal process parameters with normal results. Based on conversations with a film metallizer, it is highly likely that the thin extra metal layer could be allowed to condense onto the film in advance of the deposition of the active patterned layer. This would be a highly advantageous reduced cost process.

Either of these methods add a very thin metal underlayer to any patterned film.

This underlayer would mitigate the capacitance loss for any pattern design applied to any type of polymer film or other dielectric substrate where pattern metallization would be used to advantage for any reason.

There are other examples where a layer of other material has been applied to a dielectric polymer film prior to or following the application of metallization [in any form] to enable it to be wound into a capacitor.

U.S. Pat. No. 5,440,446 [Aug. 8, 1995] teaches that it is advantageous to coat one or both sides of a polymer film with an acrylate layer that can improve the ability of a dielectric film to [among other things] exhibit an improved ability to survive a dielectric point failure compared with that ability without such a coating.

U.S. Pat. No. 5,615,078 [Mar. 25, 1997] teaches it is advantageous for some applications to add a semiconducting refractory layer to the film to assist with self healing and to make more uniform voltage grading in the margin area, but this does not allow the same capacitance enhancement as described in the summary of the present invention.

### BRIEF DESCRIPTION OF DRAWINGS

FIGS. 1 and 1a describe a typical embodiment of prior art pattern metallized polymer film to be used for construction of wound film capacitors.

FIG. 2 shows how two mirror image films as drawn in FIG. 1 are arranged prior to being wound into a capacitor.

FIG. 3 shows a pattern that mitigates some of the issues with the pattern in FIG. 1.

FIG. 4 shows how film described by FIG. 3 is arranged prior to being wound into a capacitor.

FIG. 5 illustrates advantageous use of slope or tapered metallization.

FIG. 5a illustrates how tapered metallization can be combined with pattern metallization.

FIG. 6 illustrates in cross section the position of the underlayer enhancement to the patterned film as illustrated in FIG. 1.

FIG. 7 illustrates in cross section the position of the underlayer enhancement to the tapered patterned film as illustrated in FIG. 5a.

FIG. 8 illustrates a preferred embodiment of a traditional patterned film [FIG. 2] with the underlayer enhancement.

FIG. 9 illustrates a preferred embodiment of a modified patterned film [FIG. 4] with the underlayer enhancement.

FIG. 10 illustrates a preferred embodiment of a pattern film with the underlayer enhancement for use in a series wound capacitor.

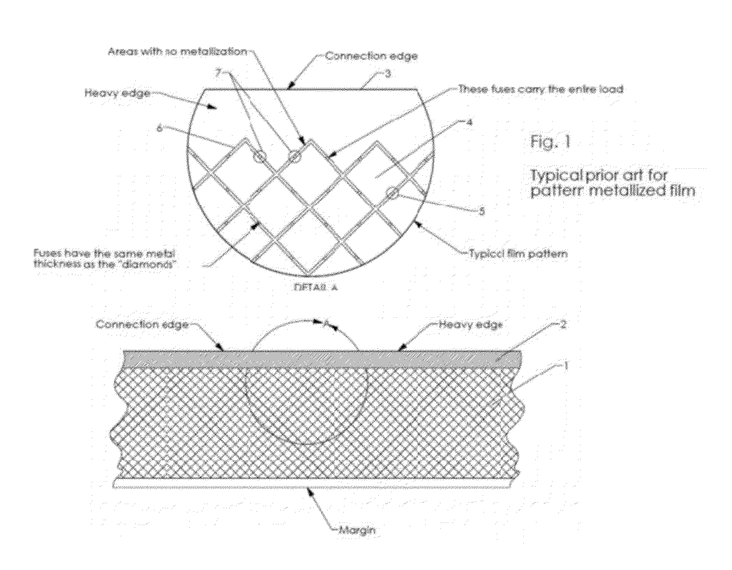

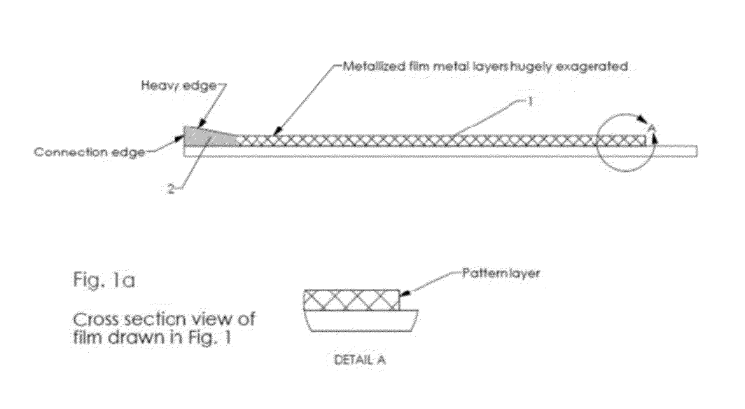

### DETAILED DESCRIPTION OF THE PREFERRED EMBODIMENTS

The idea of the present invention is very simple, and the preferred embodiments are easy to visualize.

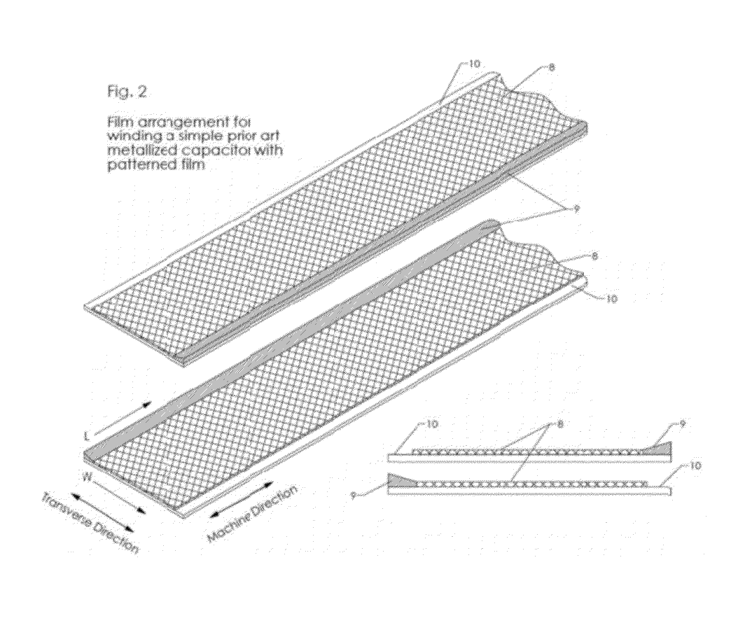

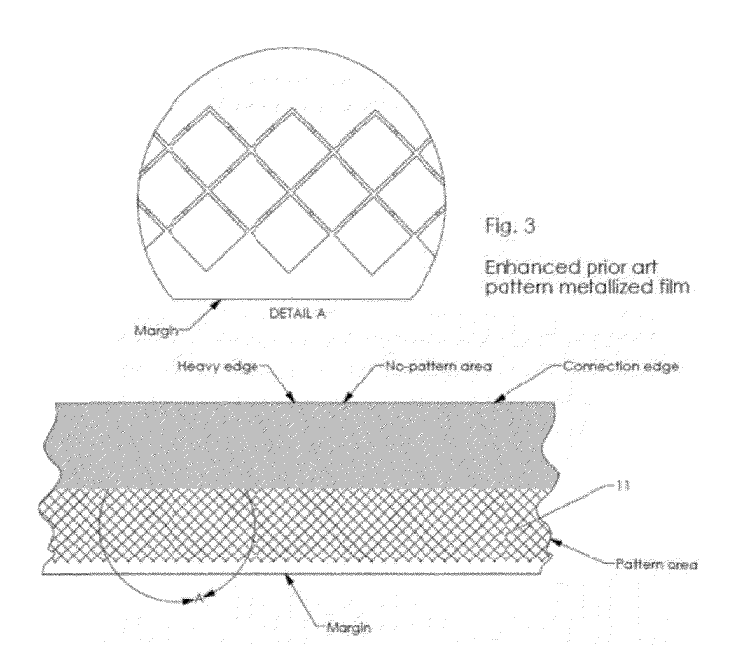

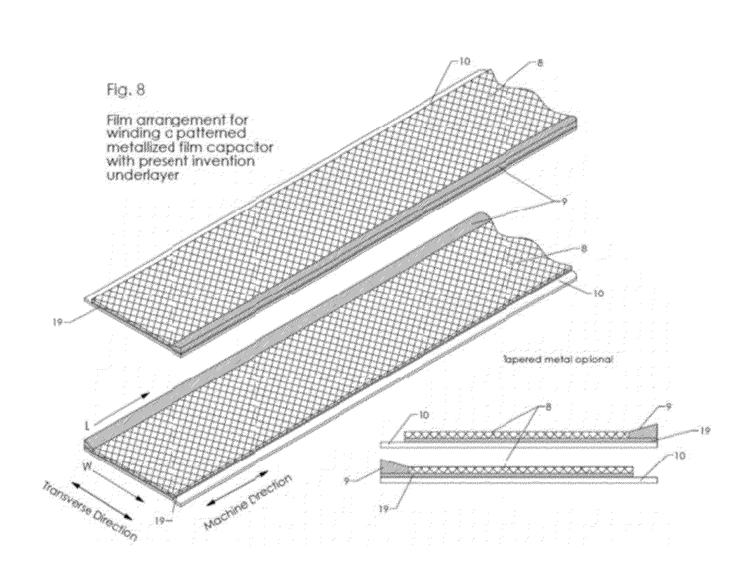

FIG. 8 shows an arrangement of two films prior to winding. Both films contain previously described underlayer (19) and one of a great many known art patterns (8) used advantageously to enhance a capacitor's ability to withstand a dielectric fault without catastrophic failure. The use of slope or tapered metal thickness can advantageously be combined with this pattern. [Other reference numbers shown on FIG. 8 are the same as on FIG. 2].

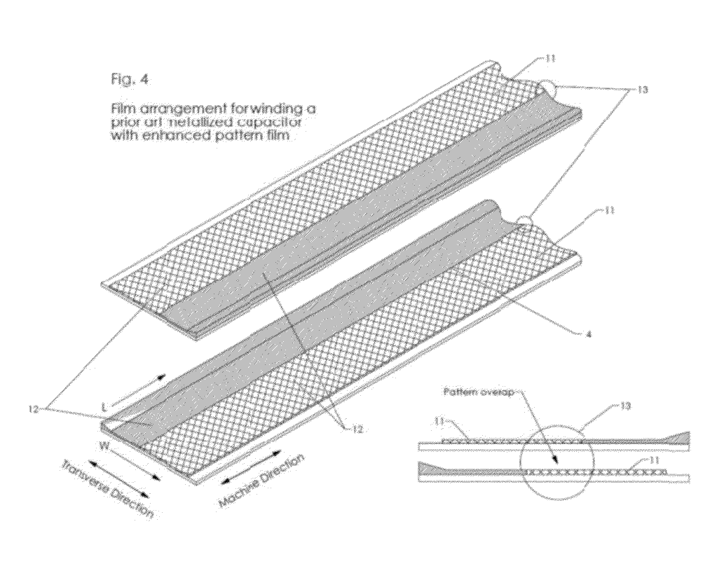

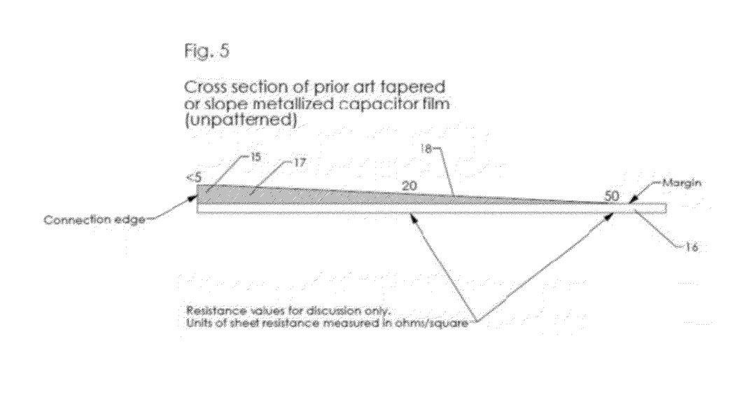

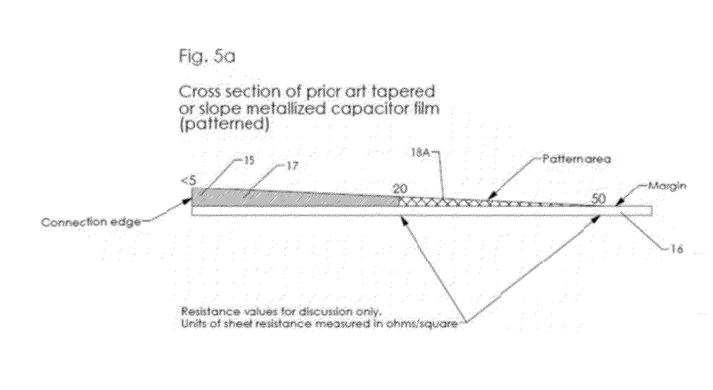

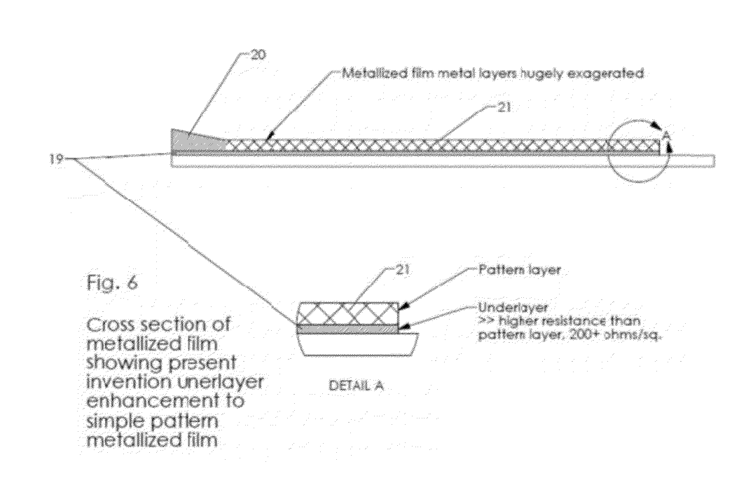

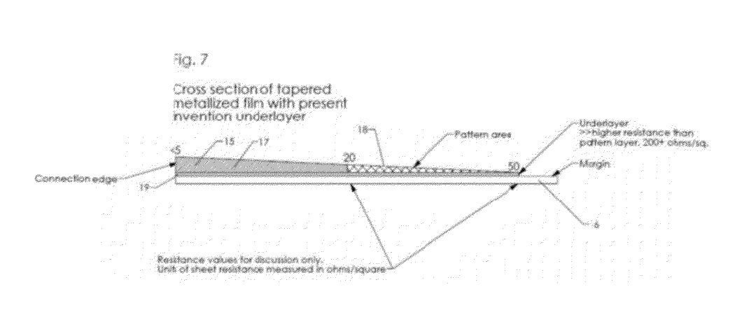

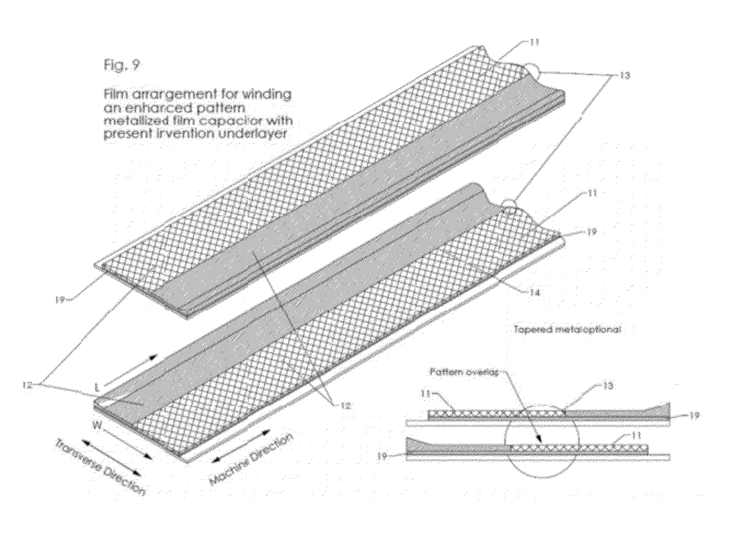

FIG. 9 shows an improved embodiment that mitigates several of the issues that arise when using a pattern illustrated in FIG. 8. This partial patterning (11) [with many possible embodiments] is also used with the underlayer (19). The use of slope or tapered metal thickness can advantageously be combined with this pattern. [Other reference numbers shown on FIG. 9 are the same as on FIG. 4]

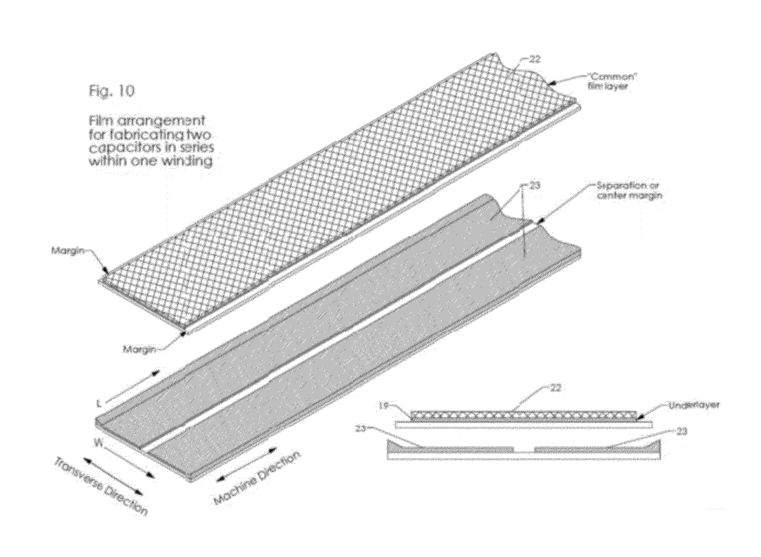

FIG. 10 illustrates use of the underlayer in the design of a capacitor winding that contains 2 series connected internal capacitors. The so called “common” metallized layer (22) contains both an underlayer and a pattern designed to enhance the capacitor's ability to survive a dielectric fault. The metallization on the 2^{nd} film (23) is not shown as patterned, but advantageously could be patterned for some applications such as described in the previously referenced U.S. Pat. No. 7,008,838.

There are a great many capacitor film metallization geometries that can result in 3 or many more internal series capacitors. The metallized underlayer is a capacitor design tool that can be used by those skilled in the related art to enhance the performance of many metallized capacitor designs where patterned metallization is found advantageous.

### Relevant Reference Patents:

U.S. Pat. No. 5,610,796 Prior art reference to show one embodiment of heavy edge metallization
   (Lavene), (Mar. 11, 1997)
U.S. Pat. No. 5,615,078 semiconducting refractory layer on capacitor film.
   (Hudis et al.), (Mar. 25, 1997)
U.S. Pat. No. 5,440,446 Acrylate coating patent.
   (Shaw et al.), (Aug. 8, 1995)
U.S. Pat. No. 5,905,628 typical specific pattern state of art pattern metallization patent
   (Okuno et al.), (May 18, 1999)
U.S. Pat. No. 7,008,838 Use of patterned metallization for purpose other than to enhance capacitor ability to survive a dielectric fault.
   (Hosking et al.), (Mar. 7, 2006)

1. A pattern metallized polymer film capacitor with an improved capacitance value comprised of alternating layers of metallized plastic film formed into a winding, an electrical terminal fastened to each end of the capacitor winding, with or without any of a variety of methods encasing the capacitor winding and terminals.

2. The device in claim 1 where the pattern metallization has been modified such that a very thin metallization layer is applied to the polymer film prior to the application of any prior art metallization pattern. This modification to the pattern film metallization increases the electrode active area to that which would be the case if no metallization pattern was employed.

3. The device in claim 1 where such modified metallization pattern is employed to raise the capacitance value to that which would be obtained if no patterned metallization was used.

4. The device in claim 3 where any metallization methods are employed to result in multiple capacitors in series within a single winding.

5. The device in claim 3 where the polymer base film has been coated with other materials having advantageous properties prior to applying capacitor electrode metallization.

6. The device in claim 3 where the metallized polymer film has been coated with other materials having advantageous properties after the metallized electrodes are applied.

7. The device in claim 3 where one skilled in the art of fabricating capacitors would find an advantageous opportunity to employ the modified metallization pattern described in claim 2.
